(19) United States
(12) Patent Application Publication
(10) Pub. No.: US 2015/0090938 A1
(43) Pub. Date: Apr. 2, 2015

(54) Method and Device for the Entrained Flow Gasification of Solid Fuels under Pressure

(71) Applicant: TECHNISCHE UNIVERSITÄT BERGAKADEMIE FREIBERG, Freiberg (DE)

(72) Inventors: Bernd Meyer, Freiberg (DE); Martin Gräbner, Freiberg (DE); Robert Pardemann, Dresden (DE)

(21) Appl. No.: 14/348,899

(22) PCT Filed: Dec. 6, 2012
(86) PCT No.: PCT/EP2012/074707

§ 371 Date: May 28, 2014

(30) Foreign Application Priority Data
Dec. 14, 2011 (DE) 10 2011 088 628.1

(51) Int. Cl. C10J 3/78; C01B 3/02; C10J 3/46; C10J 3/48; C10J 3/76; C10J 3/72

(52) U.S. Cl. CPC C10J 3/78; C10J 3/76; C10J 3/721; C10J 3/466; C10J 3/485; C01B 3/02; C10J 2200/152; C10J 2300/0959
USPC 252/373; 422/600

(57) ABSTRACT

The invention relates to a process and apparatus for entrained flow gasification of solid fuels under pressure, characterized in that first and second gasification agents containing oxygen are supplied in at least two stages to a powdery gasification stream input from above without burners so that a first, upper gasification chamber and, connected to it, a second, lower gasification chamber are formed. There is partial gasification of the gasification materials because of the addition of the first gasification agents, which are apportioned in terms of quantity and composition; temperatures arise in the first, upper gasification chamber that are greater than 600° C. Furthermore, the carbon conversion of the first gasification products is limited to a maximum of 80% with reference to the carbon input of the gasification materials. Because of the addition of the second gasification agents that are apportioned in terms of quantity and composition, temperatures arise in the second gasification chamber that are so high that complete gasification takes place for the most part and the desired composition of the raw synthesis gases of the second gasification products is achieved. In the process, the ashes are discharged in a dry form and/or in the form of melted slag.

### CROSS REFERENCE TO RELATED APPLICATIONS

This application is the U.S. national stage of International Application No. PCT/EP2012/074707 filed on Dec. 6, 2012, and claims the benefit thereof. The international application claims the benefit of German Application No. 10 2011 088 628.1 filed on Dec. 14, 2011; all applications are incorporated by reference herein in their entirety.

### BACKGROUND

The invention relates to a method and a device for the entrained flow gasification of solid fuels under pressure.

Solid fuels such as coal, petroleum coke, biomass or other carbonaceous dusts are predominantly gasified in entrained flow gasifiers and are called the gasification materials. Entrained flow gasifiers distinguish themselves by the fact that the gasification materials are brought into the gasifiers in the form of dry input via dense phase conveyance and gas as the transport medium or in the form of wet input via slurries, usually with water as the transport medium. Input into the gasification chamber takes place via burners that are flush with the reactor walls as a rule. The reactor walls and burners, especially their head areas, are water-cooled. The gasification materials are mixed with the gasification agents, which essentially consist of oxygen and steam if necessary, via the burners. Gasification flames develop in front of the burners in the process in which there are maximum temperatures of up to 3,000° C. Hot, recirculating gases that are laden with unconverted gasification material particles and slag droplets are blown around the flames. Because of the recirculation, the reaction principle is equivalent to that of a stirred-tank reactor with temperature balancing in the entire gasification chamber for the most part. The slag runoff is narrowed downwards towards a slag outlet nozzle in order to limit—in the case of gasifiers with wet quenching of the slag—the loss of heat via radiation from the gasification chamber into the slag cooling space. Furthermore, the slag flowing off the walls has to have a sufficiently low viscosity. The temperatures in the gasification chambers are appropriately set via an adjustment of the oxygen quantities in such a way that the melting temperatures of the ashes of the gasification materials are exceeded by at least 50 K. The raw synthesis gases are carried away from the gasification chambers together with the mostly liquid slag or separately from the slag.

There are fundamental differences in the structure of the walls of the gasifiers. Both water-cooled reactor walls (cooling-screen gasifiers) and brick-lined reactor walls (brick-lined gasifiers) are used for gasifiers with dry input. For reasons involving wear and tear, the latter are only appropriate if gasification materials with a very low level of ash content are gasified. In the case of wet input, brick-lined gasifiers are used as a preference.

The important drawbacks of the known entrained flow gasifiers involve:
a) the complexity of the process, which is caused by the requirements for efficient operation and flawless operation with regard to safety, in particular the operation of the burner, critical in terms of safety, including pilot burner in the case of cooling-screen gasifiers and dense phase conveyance,
b) the ineffective use of the reaction spaces as a consequence of recirculation with the resulting reduced specific output,
c) the lower gasification temperatures that can be achieved with wet input, which have the consequence of incomplete carbon conversion,
d) the high thermal and corrosive stresses of brick-lined gasifiers,
e) the comparatively large amounts of oxygen to melt the ashes at a point far over their melting temperatures,
f) the limitation of ash content to approximately 25% with reference to the dry gasification materials,
g) the risk of a shifting of the slag runoff.

The above-mentioned drawbacks involve the following in practice:

(1) investment costs that are too high (large reaction spaces and higher apparatus-related expenses, in particular for gasifiers with cooling screens and feed-in systems for dry input, (2) maintenance expenses that are too high (especially for brick-lined gasifiers), (3) operating costs that are too high (especially for covering and conveying gases for gasifiers with dry input and for the fine grinding of coal smaller than 100 μm, (4) the limitation of pressure to approx. 40 bar for gasifiers with dry input as a result of the high quantities of transfer-channel covering gases and conveying gases for the dense phase conveyance (especially for low rank coal) and (5) the susceptibility of gasification plants to malfunctions in general and with regard to the slag characteristics (especially the lack of wetting of the cooling screen or clogging of the slag outlet nozzle) and with regard to dry input (especially relocations in the dense phase conveyance system) in particular.

US 2010/0146857 A1 discloses a process for operating a multi-zone gasification reactor with the process steps:
Input of an energy-rich fuel and an oxidizing agent in a first zone,
Gasification of this energy-rich fuel with the oxidizing agent in the first zone,
Introducing a low-energy raw material containing oxygen in a second
zone and
Gasification of this low-energy starting material containing oxygen in the second zone.

Coal, oil or gas is used as the energy-rich starting material. Low-energy coal and biomass in a dry form are supplied to the gasification reactor as the low-energy starting material.

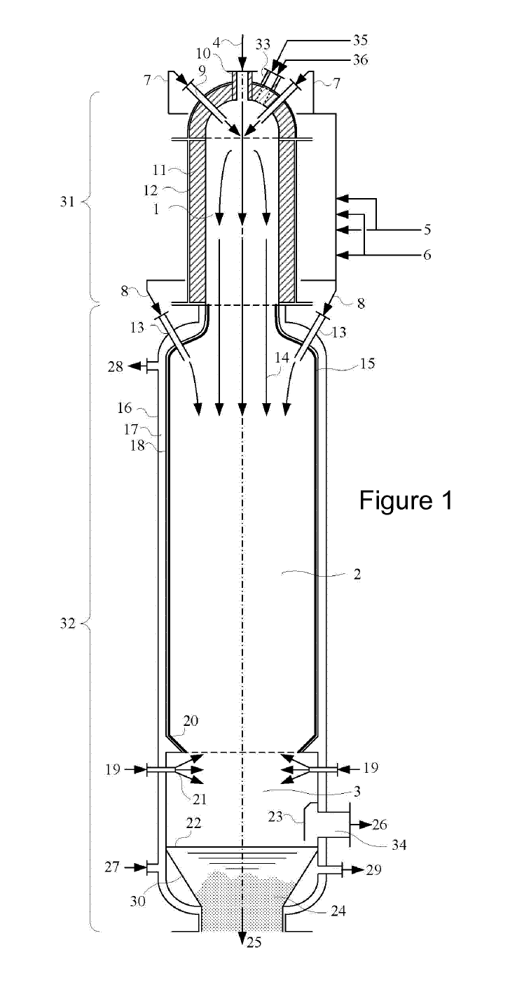

CN 101985568 A describes a two-stage, oxygen-blown pressurized gasifier with dry ash removal for ash-rich coal with high ash-melting points. This is an entrained flow gasifier with a downward directed flow with a central coal-gasification burner; its gasification intensity is to be increased via added stirred-tank behavior (cf. FIG. 1, the opposing arrangement of the nozzles (4) and (5) and the reaction space (6), enlarged with regard to its cross-section, at the level of the second stage of the oxygen input).

Solutions were presented to replace the principle of a stirring tank, which is disadvantageous on the whole, that were similar to the transport principle of a fluid catalytic cracker. The teaching according to EP 0 634 470 A1 (transport principle) is not suitable, because the drawbacks of the stirring-tank principle that are avoided are more than compensated for by other drawbacks. The process uses a combustion chamber (combuster) for coke combustion with a transitionless riser pipe (riser) in which the hot combustion gases are supposed to come in contact with the fresh gasification material. Since only temperatures below the ash sintering point can be set as a constraint of the process, recirculation of the physical heat of the solid (as a thermal transfer medium) and of unconverted gasification material in a mixture with bed material (ash or absorbencies in part) is absolutely necessary to avoid a drop in efficiency. The apparatus to be provided for the feedback of the gasification material, which is supposed to reach 10 to 250 times the quantity of the input of gasification material, causes the system to be highly complex with the consequence that the above-mentioned drawbacks (1) to (4) fully apply.

The teaching according to U.S. Pat. No. 7,547,423 B2 is another approach in which the stirring-tank behavior is supposed to be replaced by that of a compact tube reactor. Since the reactor is supposed to be based on experience with a solid rocket motor, the distribution of the gasification material and agents (burner) at the entry to the reactor has a very complicated arrangement (multiple partitioning of the solid stream into a number of small tubes) and it has a tendency towards high susceptibility to malfunctions due to its complexity. Furthermore, the interior wall of the gasifier is supposed to be covered by a fixed layer of slag, liquid towards the gas space, which cannot provide any ignition potential in the case of flame blow-off, in order to prevent an explosive breakthrough of oxygen into the path of the raw synthesis gas. That is why additional, high-level safety-related requirements are placed on the system.

The object of the invention is derived from the problems that were presented, which include the basic apparatus-related simplification of the entrained flow gasification (without burner), the increase in the gasification pressures up to 100 bar when using dry input, providing flexibility with regard to the spectrum and the grain sizes of the coal that is used, the reduction in susceptibility to malfunctions of the gasification process and safety-related simplification.

### SUMMARY

The invention relates to a method and a device for the entrained flow gasification of solid fuels under pressure characterized in that first and second oxygen-containing gasification means are supplied from above to a burnerless, dust-forming gasification material stream in at least two stages such that a first, upper gasification chamber and subsequent second, lower gasification chamber are formed. Through the addition of the first gasification agent, measured according to quantity and composition, partial gasification of the gasification materials is performed, wherein temperatures in the first, upper gasification chamber, which are greater than 600° C., are adjusted. In addition, the carbon conversion of the first gasification products is limited to 80% based on the carbon input of the gasification materials. Through the addition of the second gasification agent, measured according to quantity and composition, temperatures in the second gasification chamber are adjusted to a level that is high enough that largely complete gasification takes place and the desired compositions of the raw synthesis gases of the second gasification process are obtained. In the process, the discharge of ash in dry form and/or in the form of a melted slag is possible.

### DETAILED DESCRIPTION

The problem is solved as per the invention with a process for entrained flow gasification of solid fuels under pressure by means of an entrained flow gasifier with a pressure reactor with two gasification chambers according to claim 1. The elements of claims 2 to 5 contain further design forms.

The process for entrained flow gasification of solid fuels under pressure is carried out by means of an entrained flow gasifier with a pressure reactor with two gasification chambers and a flow oriented to be vertically downwards, into which powdery gasification materials are input from above without burner, preferably via gravity, and into which first and second gasification agents containing oxygen are fed in at least two stages, so that a first, upper gasification chamber and, connected to that, a second, lower gasification chamber are formed, and from which gasification products that are comprised of raw synthesis gases laden with liquid slag and/or solids are carried off downwards out of the gasification chambers. The first gasification agents are locally separated from the supply of gasification materials, but are input into the first gasification chamber from above at a point that is not higher than that of the gasification materials. The first gasification agents are input in at least one plane by means of first gasification agent nozzles that are distributed in a ring over at least one circumference of the entrained flow gasifier. The first gasification agents containing oxygen make up 10 to 60% of the mass of the sum of all gasification agents that are supplied, wherein the first gasification agents are apportioned in terms of quantity and composition in such a way that partial gasification of the gasification materials takes place to the effect that the first gasification products have temperatures of at least 600° C. and the carbon conversion of the first gasification products is at most 80% with reference to the carbon input of the gasification materials. The first gasification products flow from above into the second gasification chamber, which expands downward in the direction of flow and which is located under the first gasification chamber. The second gasification agents are input from above or from below and in the proximity of the inlet of the first gasification chamber. The second gasification agents are input in at least one plane by means of second gasification agent nozzles that are distributed in a ring over at least one circumference of the entrained flow gasifier. The second gasification agents are apportioned in terms of quantity and composition in such a way that there is complete gasification of the gasification materials for the most part and the desired compositions of the raw synthesis gases of the second gasification products are achieved. The description “complete gasification . . . for the most part” is used with regard to the gasification because gasification processes, and thus 100% conversion of the carbon (carbon conversion), are not complete as a rule. Complete gasification for the most part as defined by the entrained flow gasification in accordance with the invention indicates carbon conversion of 90-99.9%, 95-99.9% as a preference, especially 98-99.9% as a preference.

The process for entrained flow gasification of solid fuels under pressure as per the invention is characterized by the fact that first and second gasification agents containing oxygen are supplied in at least two stages to a powdery gasification stream input from above without burner so that a first, upper gasification chamber and, connected to it, a second, lower gasification chamber are formed. There is partial gasification of the gasification materials because of the addition of the first gasification agents, which are apportioned in terms of quantity and composition; temperatures arise in the first, upper gasification chamber that are greater than 600° C. Furthermore, the carbon conversion of the first gasification products is limited to a maximum of 80% with reference to the carbon input of the gasification materials. Because of the addition of the second gasification agents that are apportioned in terms of quantity and composition, temperatures arise in the second gasification chamber that are so high that complete gasification takes place for the most part and the desired composition of the raw synthesis gases of the second gasification products is achieved. In the process, the ashes are discharged in a dry form and/or in the form of melted slag.

The problem is solved as per the invention with a gasification reactor for entrained flow gasification of solid fuels under pressure that is comprised of a pressure reactor with a first, upper reactor part that is predominantly or completely brick-lined on the inside with a first gasification chamber, with a second, coolable and/or brick-lined reactor part with a second gasification chamber, a quenching area and a raw gas outlet with at least one bottom product discharge unit. The clear internal diameter of the second gasification chamber is 130 to 340% of the clear internal diameter of the first gasification chamber; at least one gravity-feed unit for a supply of solid gasification materials without burners is arranged at the upper end of the first gasification chamber and surrounded by gasification agent nozzles, oriented in a ring and tilted downwards in the first gasification chamber, that are there to supply the first gasification agent. Gasification agent nozzles for second gasification agents are arranged at the top or at the bottom and in proximity to the inlet of the second gasification chamber in at least one plane over at least one circumference of the entrained flow gasifier.

The gasification agent nozzles for the first gasification agent nozzles are arranged and designed in such a way here that the first gasification agents make up 10 to 60% of the mass of the sum of all gasification agents that are supplied, and the first gasification agents are apportioned in terms of quantity and composition in such a way that partial gasification of the gasification materials takes place to the effect that the first gasification products have temperatures of at least 600° C. and the carbon conversion of the first gasification products is at most 80% with reference to the carbon input of the gasification materials. The gasification agent nozzles for the second gasification agent are arranged and designed in such a way that the second gasification agents are apportioned in terms of quantity and composition in such a way that complete gasification of the gasification materials takes place for the most part and the desired compositions of the raw synthesis gases of the second gasification products are achieved.

The gasification materials are input from above, preferably through a central inlet at the highest position on the head of the first gasification chamber, into the preferably cylindrical and preferably brick-lined first gasification chamber, preferably according to the principle of gravity-feed input. If necessary, baffles or a gas flow (inert gases and/or combustible gases) can be used for an initial disaggregation of the gasification material flow.

The first gasification chamber can be advantageously designed to expand as it goes downward in terms of the free cross-section. The first gasification agents containing oxygen are likewise supplied at the head of the first gasification chamber, but not locally higher than the entry of the gasification materials. The first gasification agents are preferably input in a plane by means of first gasification agent nozzles distributed over the circumference of the pressure reactor. The first gasification agent nozzles are either designed to be water-cooled oxygen nozzles, water-cooled oxygen-steam-mixture nozzles or non-cooled binary nozzles in which the internal oxygen flow is surrounded by jacket steam in an annular flow in the form of gasification steam. The addition of the first gasification agent is to be set in such a way that the masonry in the first gasification chamber will have temperatures greater than 600° C. due to the release of heat from the gasification reactions, which ensures inherent ignition reliability and makes it possible to get rid of the classic pilot burner. If an addition of gasification agents that react endothermically (e.g. steam, carbon dioxide) is necessary for gasification materials with high calorific value to limit the temperature, the gasification agents that react endothermically will be added with the first gasification agents as a preference.

The first gasification chamber is customarily designed as an attachment on top of the second gasification chamber. The clear cross-sections on the gasification sides of the first gasification chamber attached on top and of the second gasification chamber are equally large as a preference at the transition from the first to the second gasification chamber. The second gasification chamber widens out in a transition area, dependent upon the system pressure, to a clear internal diameter of 130 to 340% of the clear diameter of the first gasification chamber. The inner wall of the second gasification chamber is preferably designed as a pressurized water jacket with natural circulation of boiling water; the inner jacket is heat insulated, preferably studded and tamped or provided with silicon carbide masonry. A further advantageous solution with regard to the heat insulation of the inner wall of the second gasification chamber is to partially or completely equip the inner wall with ceramic, heat-insulating masonry. The inner contour of the second gasification chamber is cylindrical, but it can also preferably be conically expanded by 1-2° going downwards over the entire length or over parts of the length, in order to reduce the deposits of solid material on the wall.

The second gasification agents are brought in with the descending first gasification products at or in the proximity of the inlet of the second gasification chamber in at least a plane by means of at least two gasification agent nozzles, at least 2 to a maximum of 12, distributed around a circumference of the pressure reactor. In the process, the second gasification agents can be brought in both above or below, but in the proximity of the inlet of the second gasification chamber.

The second gasification agent nozzles are either radially symmetric or tangentially aligned and are positioned 0 to 90°, preferably 60°, downwards vis-a-vis the horizontal plane. The second gasification agent nozzles are either designed to be water-cooled oxygen nozzles, water-cooled oxygen-steam-mixture nozzles or non-cooled binary nozzles in which the internal oxygen flow is surrounded by jacket steam in an annular flow in the form of gasification steam.

A downwards-oriented flow that prevents large recirculation cells from forming arises in the second gasification chamber. The addition of the second gasification agents is apportioned in such a way that complete gasification takes place for the most part, and the desired compositions of the raw synthesis gases of the second gasification products are achieved. The temperatures of the second gasification products are customarily set above the ash-melting temperatures so that liquid slag is formed. Temperatures below the ash-melting temperature can be realized in an advantageous fashion, however, when reactive gasification materials with a high melting point are used that enable sufficient carbon conversion to be achieved below the ash-melting temperature.

The second gasification chamber is limited on the downside by the quenching area. The inner wall of the gasifier is slightly constricted or preferably not constricted at all at the lower end of the second gasification chamber. This apparatus-related simplification, which makes the slag runoff nozzle that is customarily required unnecessary, is possible because the raw synthesis gases of the second gasification products are loaded with liquid slag and/or solids to such an extent that there is no radiation-related cooling of the second gasification chamber. There is a high degree of particle loading of the raw synthesis gases of the second gasification products because only a slight amount of ashes and slag arise and stick to the gasification wall due to the recirculating flow profile, so the vast majority of the ashes and slag are transported with the gas flow in the form of particles. The gasification in the second gasification chamber can be carried out at temperatures below, at or above the slag melting point because of the relatively low extent to which the inner walls of the gasifier are coated with ashes and slag.

Water for quenching of the second gasification products is sprayed into the quenching area that connects to the bottom of the second gasification chamber; the quenching ensures, on the one hand, reliable cooling of the raw synthesis gases down to temperatures below the ash sintering point and, on the other hand, brings about a preliminary precipitation of the particles into a water bath located at the lower end of the quenching area. The quenching takes the form of spray quenching; the required water flow is preferably distributed as evenly as possible over the circumference in at least one plane, and quenching nozzles that are aligned in either a radially symmetrical fashion or a tangential fashion are brought in. The direction of the stream of the nozzles is preferably set to be 0 to 30° above and/or below the horizontal plane. The raw synthesis gases leave the quenching area on the side; the gas outlet is preferably equipped with a deflector and baffle plate in front of it.

The invention makes use of the findings that the combination of (A) a complete local separation of the supply of gasification materials and the supply of gasification agents, (B) the staggered input of the gasification agents and (C) the staggered expansion of the cross-section of the gasification chambers to ensure streams in the gasification chambers that have a low level of back-mixing bring about conditions for entrained flow gasification enabling a fundamental simplification of the entire gasification technology including the expansion of the range of gasification materials. The teaching is fundamentally different than that of the prior art or the approaches to a solution presented in CN101985568A (two-stage oxygen gasifier) because of that.

The most important simplifications involve the elimination of the burner technologies that are complex in terms of the apparatus, operation and safety, the elimination of the complex and malfunction-prone dense phase conveyance of the gasification materials required for that, the reduction of the quality requirements of the gasification materials especially with regard to the limitation of the grain sizes, water content, ash content and ash qualities, the possible increase in the gasifier pressure to 100 bar and the basic simplifications of the gasification reactor and the gasification operation in terms of design, apparatus and safety.

The task of mixing the gasification material and the gasification agents is achieved via the flow in the first gasification chamber that is designed to be free of recirculation to a great extent, which is why a specific input velocity range of the powdery gasification materials made necessary by the burner technology and a limitation of grain sizes and water content of the gasification materials imposed by the dense phase conveyance are no longer required.

The use of a gravity-feed input that only requires baffles or a small gas flow (inert gases and/or combustible gases) when necessary for further disaggregation of the gasification material flow is especially advantageous. As a result, the required quantity of conveying gas is reduced down to close to that of the gas filling of the gap volume (750-2000 kg of gasification material per m³ (in operation) of gas), which makes it possible to raise the pressure level up to 100 bar without any limitations worth mentioning with regard to the quality of the raw synthesis gas (the share of inert gases is less than 7% by volume). Basically, the pressure limitation to 60 to 70 bar, which is an important drawback of all of the other entrained flow gasification processes with a dry input of gasification materials, can therefore be eliminated. Dense phase conveyance, which requires a great deal in terms of apparatus, is eliminated, and that leads to important reductions in investment and operational costs via the above-mentioned simplifications.

A separation of the gasification chamber into a first small gasification chamber and a second large gasification chamber is essential to the invention; the first gasification chamber is preferably brick-lined to a great extent to ensure stable ignition and ignition reliability without the use of a classical pilot burner. The brick lining of the first gasification chamber has to show a temperature capability in the gasifier operation of more than 600° C., preferably more than 700° C., to ensure ignition of the flow of gasification materials and gasification agents that are mixing. The heatup time for the masonry that is brought about by at least one startup burner operated with gaseous or liquid fuel and located at the upper end of the first gasification chamber is significantly reduced due to the significantly higher density of the heat flow that can be achieved because of the reduced inner diameter of the first gasification chamber, on the one hand, and by the lower end temperature that is required, on the other hand.

The startup burner advantageously remains installed during the stationary gasification operation and will preferably be flushed with a small amount of combustible gases, preferably recycled synthesis gas. This has the advantage that the startup burner does not have to be removed and it can be used for coverage, and that no nitrogen is introduced when the burner remains for flushing, which specifically impacts the quality of the gas at high pressures. Furthermore, the small addition of combustible gases provides for local heating to over 600° C. because of the exothermic reaction with the first gasification agents or with a small amount of oxygen that is added in the startup burner. Thus, additional ignition reliability is ensured that permits significantly greater flexibility with regard to the materials that are used in terms of grain size and moisture content, in addition to hot masonry at the head of the first gasification chamber.

The fact that reactor linings are subject to being worn down by the attack of liquid slag is known from “Mark J. Hornick and John E. McDaniel Tampa Electric Polk Power Station Integrated Gasification Combined Cycle Project-Final Report. Technical Report DE-FC-21-91Mc27363, 2002”, so the first gasification agents are chosen with regard to quantity and composition in such a way that partial gasification takes place in which the temperatures are so limited that little or no liquid slag arises. That is the case as a rule when the carbon conversion of the first gasification products is a maximum of 80% with reference to the carbon input of the gasification materials. The first gasification agent nozzles and the gasification material input are only subjected to slight thermal stress because of the low temperatures in the first gasification chamber. The long-term operational stability of the nozzles and other components is increased because of that.

The elimination of the classic pilot burner with a gasifier with dry coal input not only yields apparatus-related simplifications, but also reduced susceptibility to malfunctions because of the reduced complexity, a reduction in operating costs due to the heavily reduced need for fuel gas and safety-related simplification.

The first gasification agents containing oxygen for the first reaction chamber are provided via first gasification agent nozzles that are likewise arranged on the head, close to the coal inlet and symmetrically pointing downwards. It is important here that the first gasification agents are not input locally in the first gasification chamber higher than the gasification materials, in order to ensure that the first gasification agents immediately come into contact with the gasification materials that are falling downwards. It is important for safety that free carbon is still available at the lower end of the first gasification chamber so that uncontrolled reactions of free oxygen are not able to take place (inherent safety).

The required addition of endothermically reacting gasification agents (e.g. steam, carbon dioxide) for temperature limitation in the case of gasification materials with high calorific value can take place in both gasification chambers in principle. A high gas mass flow in the first gasification chamber brings about a good, thorough mixture of the first gasification agents and the gasification materials, as well as a more homogeneous velocity profile with a slight diameter difference between the two gasification chambers. The entire required quantity of endothermically reacting gasification agents will therefore preferably be added in the first gasification chamber.

The first gasification agent nozzles that are used are designed to be water-cooled oxygen nozzles, water-cooled oxygen-steam-mixture nozzles or non-cooled binary nozzles in which the internal gas flow containing oxygen is surrounded by a jacket stream in an annular flow in the form of gasification steam. The discharge velocity of the first gasification agents is between 5 and 40 m/s, preferably between 5 and 20 m/s; in the case of binary nozzles, the velocities of the jacket steam are around 10% higher than those of the internal gas flow. Carbon conversion levels of 30 to 80%, preferably 40-65%, arise in the first gasification chamber depending on the characteristics of the gasification materials (e.g. water content, reactivity, volatile content, calorific value) and on the system pressure. In the process, the particle retention times in the first gasification chamber are approx. 1 s and the gas discharge velocities at the lower end are 1 to 5 m/s, preferably 2 m/s.

According to one advantageous design form of the invention, the first gasification chamber is designed as an attachment on top of the second gasification chamber. In the second gasification chamber, further second gasification agents containing oxygen are added to the raw synthesis gas flow of the first gasification products loaded with particles, which are flowing from the first gasification chamber into the second gasification chamber. The quantities and compositions of the second gasification agents are to be apportioned in such a way that a nearly complete conversion of the carbon of the gasification materials into gaseous products and the desired compositions of the raw synthesis gases of the second gasification products are achieved.

The second gasification agent nozzles preferably have either a radially symmetric or slightly tangential orientation on a common circumference in the neck area, in order to achieve an adequate mixture of the flows, on the one hand, and a minimal formation of recirculation areas, on the other hand. A further preferred arrangement of the second gasification agent nozzles involves the arrangement of a nozzle level at the outlet of the first gasification chamber to the effect that the nozzles are tilted vertically downwards so far that the nozzle streams freely spray into the second gasification chamber. The second gasification agent nozzles can be placed in a “colder” environment that is gentler to material in that way. The discharge velocities of the gasification agents is between 5 and 40 m/s, preferably between 5 and 20 m/s; in the case of binary nozzles, the velocities of the jacket steam are around 10% higher than those of the internal gas flow.

The proportions of gasification agents containing oxygen for the second gasification chamber vary between 90 and 40% with reference to the overall gasification agent requirements in dependence upon the system pressure, the allocation of endothermically reacting gasification agents and the characteristics of the gasification materials (e.g. water content, reactivity, volatile content, calorific value). To make use of the advantages of the formation of a flow with a predominantly low level of recirculation in the second gasification chamber that have been described in accordance with the invention, the clear cross section on the gasification side has an enlargement in the upper area of the second gasification chamber. Depending on the system pressure, the clear inner diameter of the second gasification chamber widens out to 130 to 340% of the clear diameter of the first gasification chamber in a transition area. The contour of the transition area can be conical or curved and is preferably shaped in such a way that a gas-flow velocity that is as constant as possible is achieved over the cross section. The inner gasifier wall of the second gasification chamber can preferably be cooled in the form of a pressurized water jacket with natural circulation of boiling water; the outer jacket bears the pressure and the inner jacket is preferably studded and tamped or provided with heat-insulating masonry made of silicon carbide for instance. The water jacket pressure is about 1 to 3 bar above the system pressure of the gasification chamber.

The inner contour of the second gasification is cylindrical, but can also preferably be conically expanded by 1-2° going downwards over the length or over parts of the length, in order to reduce the deposits of solid material on the wall, on the one hand, and to not disturb the formation of the transport stream, on the other hand. Only around 5 to 20% of the entire slag is deposited on the cooled wall, so a permanent slag layer arises that protects the reactor wall against wear and constitutes insulation for excessive heat loss. The solid slag layer transitions into a liquid layer towards the inside, so newly deposited slag droplets can run downwards.

The reaction chamber is dimensioned in such a way that the mean gas velocities are between 1 and 5 m/s, preferably 2 m/s, at the lower end of the second gasification chamber, and the particle retention times are approx. 2 s on average after contacting the second gasification agents in the second gasification chamber.

A further advantage of the invention is that the majority of the solid or liquid gasification products remain in the gas stream and are not deposited on the wall via recirculation because of the formation of a plug flow for the most part. A narrow neck of the second gasification chamber at the transition to the quenching area, susceptible to clogging, is therefore not required, because the radiant heat losses are limited in the downwards direction by the high particle loads of the raw synthesis gases of the second gasification products. A slight constriction with a drip rail up to a maximum of 80% of the clear diameter at the lower end of the second gasification chamber is advantageous for protecting the quenching water nozzles in the upper part of the quenching area underneath the second gasification chamber from a direct impact of solids or droplets.

The reliable cooling of the raw synthesis gases down to temperatures below the ash sintering temperatures and a preliminary separation of solid particles in a water bath at the lower end of the quenching area are accomplished via an injected stream of water (quenching). In the process, the raw synthesis gas emits a part of its tangible heat to the water, which is preheated and vaporized for its part in the mixture. The outlet temperatures of the cooled raw synthesis gases are therefore close to the system-pressure-dependent saturation temperature as a preference and can be further reduced with an excess of quenching water if necessary. The quenching itself takes the form of spray quenching; the required water flow is preferably distributed evenly over at least one circumference in at least one plane, and at least three quenching nozzles that are aligned in either a radially symmetrical fashion or a tangential fashion are brought in. The direction of the stream of the nozzles is preferably set to be 0 to 30° above and/or below the horizontal plane. A sufficient outlet velocity of approximately 20 to 50 m/s ensures that the mixed-in water will at least reach the core of the gas flow.

The raw synthesis gases leave the reactor on the side via at least one outlet; the outlet is preferably protected against a short-circuit flow by at least one deflector and baffle plate in front of it. A water bath, whose filling level is regulated to be at constant heights, is located at the bottom of the quenching area. Solid gasification residues are deposited below the surface of the water and pulled off downwards. The discharge is reduced to the appropriate outlet diameter via a conical grate and periodically transferred downwards with the aid of a water stream to an outward-discharge system for solids.

### DETAILED DESCRIPTION OF THE PREFERRED EMBODIMENT

An example of the invention will be explained with the aid of FIG. 1.

FIG. 1 shows, in a heavily simplified, schematic diagram, a gasification reactor for entrained flow gasification comprised of a first brick-lined reactor part (31) and a second, lower, cooled reactor part (32) with an input of gasification materials (4) without a burner. The first brick-lined reactor part (31) of the gasification reactor for entrained flow gasification is comprised of a first gasification chamber (1) and is surrounded by a cylindrical pressure vessel, which is made up of an external pressure shell (12) and an internal, fireproof brick lining (11).

The second, cooled reactor part (32) of the gasification reactor for entrained flow gasification is located beneath the first brick-lined reactor part (31), is comprised of a second gasification chamber (2) and a quenching area (3) and is surrounded by a cylindrical pressure vessel, which is made up of an external pressure shell (16), a water space (17) and an inner shell (18). A jacket water inlet (27) and a jacket water outlet (28) ensure that there is a supply and discharge of the cooling water.

The inner clear diameter of the second gasification chamber (2) is 195% of the inner clear diameter of the first gasification chamber (1). The inner shell (18) is studded and tamped with a fireproof material (15) in the form of ceramic protection.

A brick-lined gasification-material supply connection (10), which is surrounded in the form of a ring in a plane by four gasification agent nozzles (9) for first gasification agents (7), and a brick-lined startup burner connection (33), offset towards the inside, for the startup burner are located at the upper end of the gasification reactor for entrained flow gasification.

The four gasification agent nozzles (9) for the first gasification agents (7) are positioned 45° downwards vis-a-vis the horizontal plane, distributed at regular intervals over a circumference and aligned radially.

A bottom product discharge unit (25), in which there is only discharge made of slag granules (24) that accumulates and is more or less continuously drawn off, and that builds up beneath the water level (22) in the quenching area in a conical slag grate (30), is indicated at the bottom of the gasification reactor for entrained flow gasification.

Six gasification agent nozzles (13) for second gasification agents (8) that are evenly distributed over a circumference in a plane and radially tilted downwards at a 60° angle vis-a-vis the horizontal plane, and that consequently contribute to the formation of a transport flow with a low level of recirculation, are located at the upper end in the neck area of the second gasification chamber (2). Eight quenching-water nozzles (21) that are evenly distributed over the circumference and that are each radially arranged on a horizontal plane beneath a local neck (20) of 80% of the clear inner diameter, are located in the upper area of the quenching area (3). A raw synthesis gas outlet (34), which is protected against short-circuit currents by a baffle plate (23), is located laterally in the lower area of the quenching area (3).

Powdery, hard American coal (Pittsburgh #8) (4) with a water content of 2.4% w/w, an ash content of 10.0% w/w and an ash-melting temperature of 1,350° C. is gasified at a pressure of 100 bar in the gasification reactor for entrained flow gasification with thermal output of 1,000 MW.

The quantitative supply of the first (7) and second gasification agents (8) is explained below with a reference basis of one kg of dry coal (4) for the sake of better understanding. A total of 0.6 m³ (normal state) of oxygen (5) and 0.113 kg of steam (6) are supplied to the gasification reactor for 1 kg of dry coal (2). 0.093 m³ (normal state) of oxygen (5) and 0.113 kg of steam (6) are used as the first gasification agents (7) for 1 kg of dry coal (2) in the example; the steam is used as an endothermic gasification agent because of the high calorific value of the coal. 0.507 m³ (normal state) of oxygen (5) is used as the second gasification agent (8) for 1 kg of dry coal (2). 0.0055 m³ (normal state) of dry, recycled synthesis gas (35) is supplied for one kg of dry coal (2) via the startup burner arranged on the startup burner connection (33).

2.029 kg of quenching water (19) preheated to 175° C. is sprayed in with reference to one kg of dry coal for gas cooling in the quenching area (3); approx. 10% of that is discharged again as excess quenching water (29).

The first gasification agents (7) are sprayed into the first gasification chamber (1) of the upper, brick-lined reactor part (31) via the gasification agent nozzles (9), designed to be cooled, mixed steam-oxygen nozzles, at a flow velocity of 20 m/s and a temperature of 262° C. With intensive mixing of the input materials that are involved, a vertically downward gas-solid flow forms that is up to 900° C., that makes a solid-material retention time of around 1 s possible in the first gasification chamber (1) and that leads to a gas velocity at the lower end of approximately 2 m/s. The brick lining (11) is heated up to temperatures of more than 600° C. by the flow, which is why sufficient ignition potential and ignition reliability are ensured. The vertically downward gas-solid flow leaves the first gasification chamber (1) at the lower end and goes through a widened area into the second gasification chamber (2) of the second cooled reactor part (32). The expansion goes from a 0.87 m clear diameter of the first gasification chamber (1) to a 1.7 m clear diameter of the second gasification chamber. The second gasification agents (7) are sprayed into the second gasification chamber (2) of the lower, cooled reactor part (32) via the second gasification agent nozzles (13), designed to be cooled, mixed oxygen nozzles, at a flow velocity of 20 m/s and a temperature of 25° C. With intensive mixing of the input materials that are involved, a vertically downward gas-solid/liquid flow forms that is at least 1450° C. in the lower area, that makes a solid-material retention time of around 2 s possible in the second gasification chamber (2) and that leads to a gas velocity at the lower end of approximately 2 m/s.

The products of the second gasification chamber (2) go, via a neck (20) to a clear diameter of approx. 1.36 m, into the quenching area (3), where quenching water (19) is sprayed in at a velocity of 40 m/s. With intensive mixing of the input flows, vaporization of part of the quenching water comes about in line with the tangible heat of the gas-solid-liquid flow from the second gasification chamber (2) and further cooling to approx. 256° C. because of the excess quenching water. In the process, the liquid slag droplets are granulated and precipitated together with the majority of solid powder particles in the water bath, so a settling of these slag granules (24) comes about below the level of the water surface (22). The level of the water surface (22) is held to more or less the same height because of the drainage of the excess quenching water (29). The gas flow is forced to change its direction because of a baffle plate (23) in front of the outlet of the raw synthesis gases (26), which brings about further precipitation of particles in the water bath. The solids, with a grain size of 2 mm or smaller, get to the bottom product discharge unit with a carbon content of less than 0.67% w/w.

### LIST OF REFERENCE NUMERALS

1 First gasification chamber
2 Second gasification chamber
3 Quenching area
4 Gasification material
5 Oxygen
6 Steam
7 First gasification agents
8 Second gasification agents
9 Gasification agent nozzles for the first gasification agents
10 Gasification-material supply connection
11 Brick lining
12 Outer pressure shell of the first gasification chamber
13 Gasification agent nozzles for the second gasification agents
14 Transport flow
15 Studding and tamping of the inner wall
16 Outer pressure shell of the second gasification chamber
17 Water space
18 Inner shell
19 Quenching water
20 Neck
21 Quenching-water nozzles
22 Water level in the quenching area
23 Deflector or baffle plate
24 Slag granules
25 Bottom product discharge unit
26 Raw synthesis gases
27 Jacket water inlet
28 Jacket water outlet
29 Excess quenching water
30 Conical slag grate
31 Upper, brick-lined reactor part
32 Lower, cooled reactor part
33 Startup burner connection
34 Raw synthesis gas outlet
35 Combustible gas
36 Gas containing oxygen

1. Method for the entrained flow gasification of solid fuels under pressure by means of an entrained flow gasifier with a pressure reactor with two gasification chambers and
a vertically downwards flow,
into which powdery gasification materials are input from above,
to which first and second gasification agents containing oxygen are added in at least two stages, so a first, upper gasification chamber and, connected to that, a second, lower gasification chamber are formed, and
from which gasification products that are comprised of raw synthesis gases loaded with liquid slag and/or solids are discharged downwards out of the gasification chambers,
characterized in that
the powdery gasification materials are input without a burner,
the first gasification agents are locally separated from the supply of gasification materials, but are input into the first gasification chamber from above at a point that is not higher than that of the gasification materials,
the first gasification agents are input in at least one plane by means of first gasification agent nozzles that are distributed over at least one circumference of the entrained flow gasifier,
the first gasification agents containing oxygen make up 10 to 60% of the mass of the sum of all of the added gasification agents,
the first gasification agents are apportioned in terms of quantity and composition in such a way that partial gasification of the gasification materials takes place to the effect that the first gasification products have temperatures of at least 600° C. and the carbon conversion of the first gasification products is at most 80% with reference to the carbon input of the gasification materials,
the first gasification products flow from above into the second gasification chamber, which expands downward in the direction of flow and which is located under the first gasification chamber,
the second gasification agents are input from above or from below and in the proximity of the inlet of the first gasification chamber,
the second gasification agents are input in at least one plane by means of second gasification agent nozzles that are distributed over at least one circumference of the entrained flow gasifier,
the second gasification agents are apportioned in terms of quantity and composition in such a way that there is complete gasification of the gasification materials for the most part and the desired compositions of the raw synthesis gases of the second gasification products are achieved.

2. Method according to claim 1, characterized in that endothermically reacting gasification agents are added with the gasification agents, preferably with the first gasification agents, in the case of gasification materials with high calorific value.

3. Method according to claim 1, characterized in that the second gasification agents are added in such a way that temperatures above the ash-melting point of the gasification products are achieved in the second gasification chamber.

4. Method according to claim 1, characterized in that the second gasification agents are added in such a way in the case of reactive gasification materials with a high melting point that temperatures below the ash-melting point of the gasification products are achieved in the second gasification chamber.

5. Method according to claim 1, characterized in that a startup burner is used in the first gasification chamber to initiate the entrained flow gasification that remains installed during the steady-state gasification operation and that is flushed with a small quantity of gases, preferably recycled synthesis gases.

6. Gasification reactor for the entrained flow gasification of solid fuels under pressure, comprising a pressure reactor with a first, upper reactor part that is predominantly brick-lined on the inside or completely brick-lined with a first gasification chamber, with a second, coolable and/or brick-lined reactor part with a second gasification chamber, a quenching area and at least one raw gas outlet, with at least one bottom product discharge unit, wherein the clear inner diameter of the second gasification chamber is 130 to 340% of the clear inner diameter of the first gasification chamber, wherein a gravity-feed unit is arranged at the upper end of the first gasification chamber for the supply of solid gasification materials without burners that is surrounded by gasification agent nozzles, which are oriented in a ring and tilted downwards in the first gasification chamber, for the supply of first gasification agents, wherein gasification agent nozzles for second gasification agents are arranged at the top or at the bottom and in proximity to the inlet of the second gasification chamber in at least one plane over at least one circumference of the entrained flow gasifier, wherein the gasification agent nozzles for the first gasification agent nozzles are arranged and designed in such a way here that the first gasification agents make up 10 to 60% of the mass of the sum of all gasification agents that are supplied, and the first gasification agents are apportioned in terms of quantity and composition in such a way that partial gasification of the gasification materials takes place to the effect that the first gasification products have temperatures of at least 600° C. and the carbon conversion of the first gasification products is at most 80% with reference to the carbon input of the gasification materials, wherein the gasification agent nozzles for the second gasification agent are arranged and designed in such a way that the second gasification agents are apportioned in terms of quantity and composition in such a way that complete gasification of the gasification materials takes place for the most part and the desired compositions of the raw synthesis gases of the second gasification products are achieved.

7. Gasification reactor according to claim 6, characterized in that the inner wall of the second gasification chamber is designed to be a pressurized water jacket with natural circulation of boiling water with a heat-insulating interior jacket.

8. Gasification reactor according to claim 6, characterized in that at least one startup burner aimed into the gasification chamber is arranged at the upper end of the first gasification chamber.

9. Gasification reactor according to claim 6, characterized in that the first and/or second gasification agent nozzles are designed to be water-cooled oxygen nozzles, water-cooled oxygen-steam-mixture nozzles or non-cooled binary nozzles in which the internal oxygen flow is surrounded by jacket steam in an annular flow in the form of gasification steam.
